(19) United States
(12) Patent Application Publication
(10) Pub. No.: US 2026/0264693 A1
(43) Pub. Date: Sep. 10, 2026

(54) METHOD FOR ASSESSING THE DRIVING SAFETY OF A DRIVER OF A VEHICLE

(71) Applicant: MERCEDES-BENZ GROUP AG, Stuttgart (DE)

(72) Inventor: Alexander HANUSCHKIN, Karlsruhe (DE)

(21) Appl. No.: 19/125,428

(22) PCT Filed: Sep. 15, 2023
(86) PCT No.: PCT/EP2023/075538

§ 371 Date: Apr. 29, 2025

(30) Foreign Application Priority Data
Oct. 31, 2022 (DE) 10 2022 004 075.1

(51) Int. Cl. B60W 40/09; B60W 50/14

(52) U.S. Cl. CPC B60W 40/09; B60W 50/14; B60W 2520/105; B60W 2520/28; B60W 2540/221; B60W 2540/229; B60W 2540/30; B60W 2554/801; B60W 2554/802

(57) ABSTRACT

The driving safety of a driver of a vehicle is assessed. Individual physiological and driving-specific characteristic values of the driver and media usage characteristic values of the driver are recorded, processed, and stored over a specifiable period of time during a driving operation. Based on the recorded characteristic values, a driving safety value is determined. Depending on the determined driving safety value, a recommendation or a warning is issued in the vehicle.

### BACKGROUND AND SUMMARY OF THE INVENTION

Exemplary embodiments of the invention relate to a method for assessing the driving safety of a driver of a vehicle, wherein the driver of the vehicle is identified as a person in the vehicle.

A method for determining the usage behavior of a motor vehicle system is known from DE 10 2012 014 191 A1. The motor vehicle system offers a function that can be used by a driver. The method provides that corresponding data about the use of the function is sent via a communication device arranged in the motor vehicle to a central computer.

DE 10 2021 003 489 A1 discloses a method for detecting a gradual decrease in a vehicle driver's ability to drive, in which an individual driving-specific behavior and physiological and emotional features of a driver as well as their health data are recorded and then combined and evaluated to determine the driver's ability to drive.

US 2016/0046298 A1 discloses a system including a motion sensor that can be used to create substantially real-time mapping of driver movement during the journey. An event that distracts a driver can be detected based on this data.

US 2021/0398562 A1 is concerned with a computer-implemented method for playing back media content, wherein the mental state of the user is determined based on sensor data.

US 2022/0242233 A1 is concerned with a method and an apparatus for detecting hazardous vehicle events and encouraging the use of functions that prevent the occurrence of hazardous events.

US 2007/0275770 A1 is concerned with a hands-free device that is fastened to the sun visor of a vehicle and communicates with a remote hands-free device.

Exemplary embodiments of the present invention are directed to a method for assessing the driving safety of a driver of a vehicle.

A method for assessing the driving safety of a driver of a vehicle, wherein the driver of the vehicle is identified as a person in the vehicle, provides according to the invention that individual physiological and driving-specific characteristic values of the driver and media usage characteristic values of the driver are recorded, processed, and stored over a specifiable period of time during a driving operation. In addition, a driving safety value is determined based on the recorded characteristic values and depending on the determined driving safety value, a recommendation or a warning is issued in the vehicle. Furthermore, the driving safety is mapped as a function of vehicle and media usage characteristic values. In particular, an individual driving safety of the driver can be mapped based on the vehicle and media usage characteristic values. Based on a performed function approximation, the vehicle and media usage characteristic values that influence the value the driving safety, in particular negatively, are identified. For example, methods can be used for this purpose which can identify those features that have the greatest influence on function values, in particular for assessing driving safety, and are applied to an individual function approximation.

By using the method, the risk of the driver being distracted, in particular in relation to media usage, can be reduced, so that an accident risk for the vehicle and, if appropriate, for road users in the immediate environment of the vehicle can be reduced by using the method.

In particular, the risk of an accident can be significantly reduced by detecting individual vehicle and media usage, which increases a personal risk of being involved in and/or causing a road accident, since using media in the vehicle is in particular a possible source of distraction. By employing the method, the driver is therefore given the opportunity to adapt their behavior and thus reduce the risk of an accident.

To that end, one embodiment of the method provides that physiological characteristic values of the driver are determined based on the driver's heart rate, respiratory rate, and skin conductance value. Based on the physiological characteristic values, it can be determined, in particular, whether the driver is comparatively relaxed or in a state of stress. Particularly in stressful situations, the risk of an accident can increase, since the driver reacts in a panic and/or tends not to notice other road users.

In a further embodiment, driving-specific characteristic values of the driver are determined based on accelerations of the vehicle, wheel speeds, engine speeds, driver assistance interventions, lateral positions of the vehicle in its lane, and/or distances to vehicles driving in front. Based on these driving-specific characteristic values, a correlation can be produced between a distraction for the driver and the driver's way of driving as a result of the distraction. If the distance to a vehicle driving in front decreases and/or the vehicle drives over a lane marking, it can be assumed that the driver of the vehicle is distracted, in particular due to particular media usage, for example operating a mobile device.

In one possible refinement of the method, media usage characteristic values are determined based on user operations of a mobile device, user operations of an infotainment system of the vehicle, and/or volumes set for media playback in the vehicle. For example, in the case of media playback at a comparatively high volume, one driver of the vehicle is more distracted from the road than another driver, meaning that the driving safety assessments of the two drivers differ despite the same conditions.

A media usage of the driver is analyzed in one embodiment by means of computer-assisted speech analysis methods. In particular, the media usage can be analyzed by means of computer-assisted speech analysis in terms of content and how this then affects a driver's mood, in order to assess the driver's driving safety when they are driving the vehicle and, if need be, to alert the driver that they are being distracted by this media usage.

To that end, one embodiment of the method can provide that emotions of the driver are determined based on recorded facial, speech, and/or physiological signals. Based on the determined emotions of the driver, it is possible to ascertain comparatively reliably that the driver is being distracted by the media usage.

In addition, the method provides in one embodiment that the driver is recommended an alternative media usage in the vehicle because of a driving safety value predicted at least on the basis of the media usage signals. To that end, in particular the media usage of the driver of the vehicle is analyzed in real-time, during which the value for assessing the driving safety is determined and, for example, depending on determined physiological values of the driver, the driver is advised to consume, i.e., to listen to, relaxing media, in the form of music, for example.

Furthermore, the method provides in one possible design form that the individual physiological and driving-specific characteristic values of the driver and the media usage characteristic values of the driver recorded over the specifiable period of time during the driving operation are transmitted to a central processing unit that is coupled via a data link to the vehicle.

As an alternative or in addition to the processing and storage of the recorded characteristic values in the vehicle, these can be transmitted to the central processing unit for aggregation, processing, and storage. In this case, vehicles in a vehicle fleet transmit the respectively recorded characteristic values to the central processing unit in order to identify the characteristic values, in particular in order to determine factors that are relevant for the vehicle fleet, for example relating to media usage and the respective distraction caused thereby.

### BRIEF DESCRIPTION OF THE DRAWING FIGURES

Exemplary embodiments of the invention are explained in more detail in the following with reference to drawings, in which:

FIG. 1 schematically shows a device for carrying out a method for assessing the driving safety of a driver of a vehicle, and

FIG. 2 schematically shows a one-dimensional diagram of media usage-dependent driving safety.

Mutually corresponding parts are given the same reference signs in all of the figures.

### DETAILED DESCRIPTION

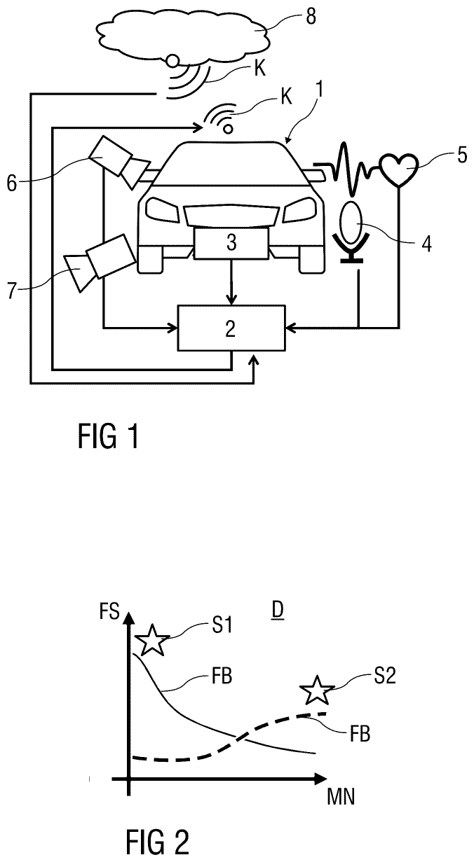

FIG. 1 shows a vehicle 1 and a device for carrying out a method for assessing the driving safety FB of a driver (not shown in more detail) of the vehicle 1, whereas FIG. 2 shows a diagram D of driving safety FS dependent on media usage MN.

It is generally known that a relatively large proportion of traffic accidents are caused by the driver being distracted when they are driving the vehicle 1. A possible source of distraction to the driver 1 is in particular media usage MN, i.e., using a mobile device, in particular operating a smartphone, selecting podcasts, music, and/or operating an infotainment system of the vehicle 1.

The method described hereinafter allows the driver of the vehicle 1 to recognize which individual media usage MN increases their personal risk of being involved in and/or causing a road accident. In addition, the method gives the driver the opportunity to adapt their behavior and thus reduce the risk of an accident.

The device has a control unit 2, a further control unit 3, for example an assistance system, at least one interior microphone 4, at least one vital signs sensor 5, at least one interior camera 6, at least one exterior camera 7, and a central processing unit 8 to which the vehicle 1, in particular the control unit 2, is coupled via a data link. The vehicle 1 belongs to a vehicle fleet, to which further vehicles (not shown) belong, which are likewise coupled to the central processing unit 8 via a data link.

In particular, signals recorded by means of the interior microphone 4, the vital signs sensors 5, the interior camera 6, the exterior camera 7, and the further control unit 3 are aggregated and logged in the control unit 2. In the process, the driver's interactions with the vehicle 1 are logged, i.e., stored, in the control unit 2 in particular.

The driver of the vehicle 1 can be identified using a plurality of methods, for example by image signals recorded by the interior camera 6 and/or the exterior camera 7, and known methods, for example by means of computer-assisted vision, for example in relation to facial recognition, using a personalized vehicle key and/or by inputting a personal identification number in the vehicle. In particular, the driver is identified as a person, so that recorded signals and, on the basis thereof, recorded values and data can be uniquely assigned to this person. Personal information and features of the driver, such as their age and/or whether the driver is a smoker, can be saved in a personal driver profile.

Thus it is possible individual physiological and driving-specific characteristic values/data in the vehicle 1 based on signals recorded by an abovementioned sensor system installed in the vehicle 1 are determined and are processed in the control unit 2.

For instance, physiological characteristic values/data, such as a heart rate, a respiratory rate, a skin conductance value, etc., can be determined based on signals recorded by the at least one vital signs sensor 5. Alternatively or additionally, these characteristic values/data can be determined based on signals recorded by optical and/or electronic sensors in the vehicle 1 or in the vehicle seat.

Driving-specific, in particular driving-dynamics characteristic values/data in relation to the driver can be determined based on signals recorded by acceleration sensors of the vehicle 1 and further sensors, on the basis of which recorded signals, for example, wheel speeds and/or engine speeds are determined. Based on the recorded and processed signals, lateral acceleration, longitudinal acceleration, a speed distribution, a maximum engine speed, and a distribution of the engine speeds can be determined, for example.

Driver-specific characteristic values/data can moreover be extracted based on information available from the further control unit 3. Thus, for example, a number of driver assistance interventions can be used, for example initiated emergency braking, steering wheel interventions to keep to a lane, and information about lateral positioning of the vehicle 1 in its lane, and/or information about distances to vehicles driving in front selected by the driver of the vehicle 1.

In addition, it is possible to recognize emotions of the driver, for example based on recorded facial, speech, and/or physiological signals by means of a suitable sensor system present in the vehicle 1, in particular the interior camera 6. Thus, for example, a physiological stress reaction of the driver can be recognized.

Characteristic values/data relating to an individual driver-specific way of driving or an individual driver-specific driving behavior can be determined by a plurality of methods. For example, the driving behavior can be classified on the basis of recorded sensor signals.

It is also conceivable that emotional feedback from other road users in the vicinity of the vehicle 1 can be used to assess the individual way of driving or the driving behavior of the driver of the vehicle 1.

The method for assessing the driving safety of the driver of the vehicle 1 provides that in the vehicle 1 characteristic values/data about individual physiological, emotional, driver-specific driving-dynamic, and driving-behavior-specific information about the driver are logged and aggregated over a specifiable, comparatively lengthy period of time in the control unit 2 of the vehicle.

For every driver of the vehicle 1, a driver-related value for the driving safety assessment FB, i.e., a driver-related performance parameter, is determined from a driver-specific feature space. This value for the driving safety assessment FB forms, as it were, a characterization of the driver's driving style, and characterizes or assesses the safety of the driver's way of driving.

Furthermore, an individual vehicle usage and in particular media usage MN is determined based on signals recorded by the vehicle's sensor system.

Vehicle usage that is recorded includes switching on an air-conditioning unit, opening a sunroof, etc. In particular, media usage characteristic values are determined in the process.

Media usage that is recorded includes operating a mobile device of the driver, i.e., a smartphone, selecting podcasts, music, and/or operating an infotainment system in the vehicle 1, a selected media playback volume etc., likewise based on signals recorded by the sensor system installed in the vehicle 1.

For further differentiation of the media usage MN, it can be analyzed by means of computer-assisted speech analysis methods, for example in terms of content, sentiment, or similar.

In a further embodiment of the method, additional personal physiological and driver-specific characteristic values/data can be used to expand the abovementioned feature space.

Based on vehicle usage characteristic values and the media usage characteristic values, an individual mapping of the driver's driving safety assessment FB can be created as a function of the vehicle usage characteristic values and the media usage characteristic values.

For this purpose, a heuristic function approximation can be used, for example a linear mapping of the media usage characteristic values with a target value of the driving safety assessment FB. Alternatively or additionally, function approximations with machine learning methods can be learned or trained in the vehicle 1. For this purpose, the vehicle and media usage characteristics are used as input parameters and the driving safety assessment FB is used as target value. Machine learning algorithms then determine that function approximation that can best map the characteristic values to the correspondingly associated target values.

Based on the function approximations it is possible to identify the vehicle and media usage characteristics negatively influencing the individual driving safety assessment FB. For example, methods which can identify the features having the greatest influence on function values, a so-called feature analysis, can be applied to the individual function approximation.

In the case of individual vehicle and in particular media usage MN negatively influencing driving safety FS when the vehicle 1 is being driven, an acoustic, visual, and/or haptic warning can be issued to the driver in the vehicle 1. For this purpose, a current individual vehicle and media usage MN is analyzed in real time and mapped by means of the function approximation as a driving safety FS value. If it is determined that the driving safety FS value drops below a specified threshold, the visual, acoustic and/or haptic warning is issued in the vehicle 1.

In a further embodiment of the method, as an alternative or in addition to issuing the warning, handling options can be suggested to the driver that do not substantially negatively influence driving safety FS, but may positively increase it.

Furthermore, the method provides that individual mappings and/or the underlying characteristic values are transmitted by means of wireless communication K from the vehicle 1 to the central processing unit 8, which can be a so-called cloud or a data center of a vehicle manufacturer. There, the characteristic values are aggregated and processed in order to identify the characteristic values that are relevant for the vehicle 1 and the further vehicles in the vehicle fleet, in particular for driving safety FS related to media usage MN.

In one exemplary embodiment, a driver is driving a comparatively top-of-the-range luxury vehicle as vehicle 1 and switches on the infotainment system in the vehicle 1. The driver selects a podcast to play in the vehicle 1. Based on the speech analysis performed in relation to the podcast, it is recognized that the podcast is about a current stock market report for a particular company.

Based on the function approximation, a significantly poorer assessment of the driving safety FS is predicted for the characteristic values “stock market report for the particular company”, “increased resting heart rate”, and “increased skin conductance value”, whereupon another podcast or relaxing music is suggested to the driver as an alternative.

In the exemplary embodiment illustrated in FIG. 2, a diagram D is shown with a respective driving safety assessment FB assigned to a driver for media usage MN.

For a driver whose driving safety assessment FB is shown using a solid line, a highest driving safety FS value is achieved when a media usage MN has a value of zero, i.e., there is no media usage MN when the vehicle 1 is being driven. This highest value is represented by means of a star S1.

For a further driver, whose driving safety assessment FB is shown by means of a dashed line, by contrast, the driving safety FS value goes up as the media usage MN value goes up.

The media usage MN, in particular the characteristic value thereof, may be the volume set for media playback in the vehicle 1, for example.

In the case of the driver with the driving safety assessment FB shown using the solid line, merely switching on the infotainment system can cause the driving safety FS value to drop. In the case of the further driver, such a circumstance can lead to the driving safety FS value associated with increasing volume increasing the driving safety FS as the vehicle 1 is being driven, as is shown by way of example using a further star S2.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-8. (canceled)

9. A method for assessing driving safety of a driver of a vehicle, the method comprising:
identifying the driver of the vehicle as a person in the vehicle;
recording, processing, and storing individual physiological and driving-specific characteristic values of the driver and media usage characteristic values of the driver over a predetermined period of time during a driving operation of the vehicle;
determining a driving safety value based on the individual physiological and driving-specific characteristic values of the driver and media usage characteristic values of the driver; and
issuing, depending on the determined driving safety value, a recommendation or a warning in the vehicle,
wherein the driving safety of the driver is mapped as a function of vehicle and media usage characteristic values,
wherein based on a function approximation, the individual physiological and driving-specific characteristic values of the driver and media usage characteristic values of the driver influencing the driving safety value are identified.

10. The method of claim 9, wherein the individual physiological characteristic values of the driver are determined based on a heart rate of the driver, a respiratory rate of the driver, and a skin conductance value of the driver.

11. The method of claim 9, wherein the driving-specific characteristic values of the driver are determined based on accelerations of the vehicle, wheel speeds of the vehicle, engine speeds of the vehicle, driver assistance interventions of the vehicle, lateral positions of the vehicle in the vehicle's lane, or distances to vehicles driving in front of the vehicle.

12. The method of claim 9, wherein the media usage characteristic values of the driver are determined based on user operations of a mobile device, user operations of an infotainment system of the vehicle, or volumes set for media playback in the vehicle.

13. The method of claim 9, wherein a media usage of the driver is analyzed using computer-assisted speech analysis.

14. The method of claim 9, wherein emotions of the driver are determined based on recorded facial, speech, or physiological signals of the driver.

15. The method of claim 13, wherein the driver is recommended an alternative media usage in the vehicle based on a driving safety value predicted at least based on the media usage.

16. The method of claim 9, wherein the individual physiological and driving-specific characteristic values of the driver and the media usage characteristic values of the driver recorded over the predetermined period of time during the driving operation are transmitted to a central processing unit coupled via a data link to the vehicle.
